(19) United States
(12) Patent Application Publication
(10) Pub. No.: US 2015/0040674 A1
(43) Pub. Date: Feb. 12, 2015

(54) ELECTROSTATIC CAPACITIVE PRESSURE SENSOR

(71) Applicant: Azbil Corporation, Tokyo (JP)

(72) Inventors: Takuya ISHIHARA, Tokyo (JP); Hidenobu TOCHIGI, Tokyo (JP); Yasuhide YOSHIKAWA, Tokyo (JP); Masashi SEKINE, Tokyo (JP)

(73) Assignee: Azbil Corporation, Tokyo (JP)

(21) Appl. No.: 14/453,684

(22) Filed: Aug. 7, 2014

(30) Foreign Application Priority Data
Aug. 9, 2013 (JP) 2013-166832

(51) Int. Cl. G01L 9/12

(52) U.S. Cl. CPC G01L 9/12
USPC 73/724

(57) ABSTRACT

An electrostatic capacitive pressure sensor includes: a housing having an inlet portion for a fluid; a sensor chip that detects, as a change in electrostatic capacitance, a change in a diaphragm that flexes upon receipt of a pressure of the fluid, which has entered through the inlet portion; and a baffle that prevents deposition, onto the diaphragm, of a contaminating substance included in the fluid, provided within a flow path of the fluid that is subject to measurement between the inlet portion and the diaphragm. The baffle has a cylindrical structure that is closed on one end, disposed with the direction that is perpendicular to a pressure-bearing surface of the diaphragm as the axial direction. A plurality of flow paths, in which the fluid passes between the inner peripheral surface and the outer peripheral surface of the cylindrical structure, is provided in multiple layers in the axial direction.

### CROSS REFERENCE TO RELATED APPLICATION

This application claims priority under 35 U.S.C. §119 to Japanese Patent Application No. 2013-166832, filed on Aug. 9, 2013, the entire content of which being hereby incorporated herein by reference.

### FIELD OF TECHNOLOGY

The present invention relates to an electrostatic capacitive pressure sensor for detecting, as a change in electrostatic capacitance, a change in a diaphragm (a partitioning film) that flexes when subjected to pressure of a fluid that is subject to measurement.

### BACKGROUND

Conventionally, electrostatic capacitive pressure sensors for detecting, as a change in electrostatic capacitance, a change in a diaphragm that flexes when subjected to pressure of a fluid that is subject to measurement have been widely known. For example, electrostatic capacitive pressure sensors are used in measuring pressure of a vacuum state in a thin film deposition process in semiconductor manufacturing equipment, and the like, where electrostatic capacitive pressure sensors for measuring pressure of the vacuum state are known as “diaphragm vacuum gauge.”

This type of diaphragm vacuum gauge has a housing that has an inlet portion for the fluid that is subject to measurement, and detects, as a change in electrostatic capacitance, a change in the diaphragm that flexes when subjected to the pressure of the fluid that is subject to measurement, which enters in through the inlet portion of the housing.

With this diaphragm vacuum gauge, fundamentally a substance that is the same as that of the thin film in the process, or a byproduct thereof, is deposited on the diaphragm. Hereinafter, this substance that is deposited shall be referred to as a “contaminating substance.” When this contaminating substance is deposited on the diaphragm, a flexure of the diaphragm is produced by the stress thereof, causing a shift in the output signal of the sensor (“zero-point drift”). Moreover, because the contaminating substance that is deposited causes an increase in the apparent thickness of the diaphragm, the diaphragm becomes more resistant to flexing, which reduces the amplitude of change (the “span”) of the output signal accompanying the application of the pressure, when compared to the span of the proper output signal.

Given this, in a diaphragm vacuum gauge, between the inlet portion and the diaphragm, a baffle is provided to prevent the deposition, onto the diaphragm, of the contaminating substances that are included in the fluid that is subject to measurement, with the plate surfaces thereof perpendicular to the direction of passage of the fluid that is subject to measurement.

A structure for attaching a baffle in a conventional diaphragm vacuum gauge is illustrated in FIG. 16. In this figure, 100 is a housing, and 100A is an inlet portion for the fluid that is subject to measurement, provided in the housing 100, where a single baffle 101, of a disk shape, is provided between the inlet portion 100A and the diaphragm (not shown), with the plane surface thereof perpendicular to the direction of flow F of the fluid that is subject to measurement.

In the baffle 101, tabs 101a are formed with a specific angular spacing on the outer peripheral portion thereof, where the fluid that is subject to measurement flows through the gaps 101b between these tabs 101a, to be supplied to the diaphragm. That is, the fluid that is subject to measurement that has been directed through the inlet portion 100A strikes the surface of the plate in the center of the baffle 101, and is redirected to pass through the gaps 101b between the tabs 101a in the baffle 101, to be supplied to the diaphragm. Doing so prevents the deposition, onto the diaphragm, of contaminating substances that are included in the fluid that is subject to measurement, rather than the fluid that is subject to measurement contacting the diaphragm directly.

However, unlike the gas-phase film deposition in CVD and PVD (sputtering, vapor deposition, and the like), in the film deposition process known as ALD (Atomic Layer Deposition), the operating principle of the film deposition is that of a surface reaction, and thus with a single baffle wherein the spacing is wide, as illustrated in FIG. 16 (a standard baffle), the deposition of the contaminating substances onto the diaphragm is not prevented completely.

Given this, in recent years there have been proposals for methods by which to promote the adhesion of contaminating substances en route, and to reduce the adhesion thereof onto the diaphragm, through causing the flow path, from the inlet portion to the diaphragm, for the fluid that is subject to measurement to be narrower and complex.

For example, in Japanese Unexamined Patent Application Publication No. 2011-149946 (the “JP '946”), as illustrated in FIG. 17, the structure is one wherein a first baffle 202 and a second baffle 203 are disposed prior to the diaphragm 201, to create a radial-direction flow path 204 that has a high length-to-width ratio (at least 1:10) between the first baffle 202 and the second baffle 203, to thereby cause the flow of the fluid that is subject to measurement (a gas) to be molecular flow, thus promoting the adhesion of the contaminating substances onto the inside of the flow path.

Note that FIG. 17 is a lengthwise sectional diagram of half of the sensor, wherein 200 is a housing and 200A is an inlet portion for the fluid that is subject to measurement, provided in the housing 200. The fluid that is subject to measurement, from the inlet portion 200A, passes through peripheral edge opening portions 202a of the first baffle 202, a radial-direction flow path 204 between the first baffle 202 and the second baffle 203, and a space (an annular sector) 205 between the outer periphery of the second baffle 203 and the housing 200, to arrive at the diaphragm 201.

Moreover, while in the JP '946, the flow of the fluid that is subject to measurement (a gas) that flows through the radial-direction flow path 204 is defined as a molecular flow, “molecular flow” is a specialized term in vacuum technology, a gas flow wherein the mean free length of the gas molecules in question is longer than a typical length for the flow of that gas, in which case the frequency of collision with the walls of the structure is larger than that of the collision of the gas molecules with each other, which promotes the adhesion of the contaminating substances to the interior of the flow path.

Conversely, the flow of gas such that the mean free length of the gas molecules in question is shorter than the typical length of the flow of the gas is known as “viscous flow.” In the viscous flow domain, the gas molecules essentially do not collide with the wall surfaces in the structure. Moreover, an intermediate gas flow is known as the “intermediate flow,” wherein, if the typical length is defined as L and the mean free length is defined as λ, then these can be classified, typically, by the below, found in the cited document as well:

Viscous Flow: λ/L<0.01

Intermediate Flow: 0.01<λ/L<0.3

Molecular Flow: 0.3<λ/L.

λ/L is known as the Knudsen number, an indicator as to whether the collisions between molecules dominate in the gas flow, or whether the collisions with the sidewalls of the flow dominate instead. For example, the mean free length of nitrogen at 150° C. is about 70 μm at 133 Pa, so if the typical size of the flow path (the radius, width, height, and the like) is less than that, the efficiency with which contaminating substances adhere increases dramatically.

However, when, in order to promote the adhesion of the contaminating substances, the flow path from the inlet portion to the diaphragm is made narrow and complex, it becomes difficult for the gas to enter into the space in the vicinity of the diaphragm, at the end of the long and complex flow path, causing the speed of response of the sensor to be slow, which places constraints on the design. That is, conventionally, while the efficiency of adhesion of the contaminating substances has been increased by narrowing and lengthening the flow paths, this has reduced the response speed of the sensor as well, making it necessary to add constraints to the narrowness and length of the flow path so as to not lose the immediacy of the response speed, where these have become constraints on the design.

Moreover, in the JP '946, the creation of the radial-direction flow with the high length-to-width ratio between the first baffle and the second baffle has a constraint in terms of the size that is the condition for the molecular flow in the direction that is perpendicular to the pressure-bearing surface of the diaphragm, but there is no constraint on the direction that is parallel to the surface of the diaphragm, in which case it is likely that the design is such that the molecules in the fluid that is subject to measurement can move freely in the direction that is parallel to the surface of the diaphragm, which, ultimately, creates a state wherein the conditions for a molecular flow are not fully satisfied, thus preventing full effectiveness. In other words, when the directions of the velocity vectors of the molecules in the fluid that is subject to measurement are parallel or nearly parallel to the surface of the diaphragm, then the molecules pass through the baffle without colliding with the wall.

The present invention was created in order to solve problems such as these, and an aspect thereof is to provide an electrostatic capacitive pressure sensor that relaxes the constraints in design and that promotes the adhesion of contaminating substances within the flow path without a loss of immediacy in the response speed of the sensor through making the flow path narrower and more complex.

### SUMMARY

In order to achieve such an aspect, the electrostatic capacitive pressure sensor according to the present invention includes: a housing having an inlet portion for a fluid that is subject to measurement; a sensor chip that detects, as a change in electrostatic capacitance, a change in a diaphragm that flexes upon receipt of a pressure of the fluid that is subject to measurement, which has entered through the inlet portion; and a baffle for preventing deposition, onto the diaphragm, of a contaminating substance included in the fluid that is subject to measurement, provided within a flow path of the fluid that is subject to measurement between the inlet portion and the diaphragm, wherein: the baffle structure is a cylindrical structure that is closed on one end, disposed with the direction that is perpendicular to a pressure-bearing surface of the diaphragm as the axial direction; and a plurality of flow paths wherein the fluid that is subject to measurement passes between the inner peripheral surface and the outer peripheral surface of the cylindrical structure is provided in multiple layers in the axial direction.

In this invention, the baffle structure is a structure wherein one end is closed. In the baffle structure, a plurality of flow paths that pass between the inner peripheral surface and the outer peripheral surface of the cylindrical structure is provided with multiple layers in the axial direction, where the fluid that is subject to measurement flows through the plurality of flow paths that are provided in the multiple layers in the axial direction. While, in this baffle structure, the conductance of a single flow path is extremely small, the overall conductance is made large through the provision of this flow path in a plurality, and through the provision of multiple layers, with these pluralities of flow paths, in the axial direction. The spacer possible to relax the constraints in design and to promote the adhesion of contaminating substances within the flow path without a loss of immediacy in the response speed of the sensor through making the flow path narrower and more complex.

In the present invention, the diameters, or widths and heights, of the flow paths provided in the baffle structure preferably are widths and heights that cause the fluid that is subject to measurement, flowing therethrough, to form molecular flow (for example, between 10 and 200 μm). If too narrow, then the flow paths would become narrowed when the contaminating substances become adhered, which could slow the response speed of the sensor, but if too wide, then there would cease to be molecular flow, which would prevent the desired effect. Moreover, the length of the flow path provided the baffle structure preferably is no less than between about 3 and 20 mm, although this is dependent on the number of flow paths that are provided in parallel.

Having the diameters, or widths and heights, of the flow paths provided in the baffle structure be widths and heights that cause the fluid that is subject to measurement, flowing therein, to form molecular flows constrains not only the size that is the condition for forming molecular flows in the direction that is perpendicular to the pressure-bearing surface of the diaphragm, but also constrains the size that is the condition for forming molecular flow in the direction that is parallel to the surface of the diaphragm, making it possible to obtain a full effect.

Moreover, while in the present invention a baffle structure is provided within the flow path through which the fluid that is subject to measurement flows between the inlet portion and the diaphragm, the method by which this baffle structure is provided may be a method such as follows.

### Method 1

### A Method Wherein the Fluid that is Subject to Measurement Passes from the Inner Peripheral Surface Side of the Baffle Structure to the Outer Peripheral Surface Side Thereof

In the first method, a baffle structure is provided wherein the fluid that is subject to measurement is introduced into the inner peripheral side, and this fluid that is subject to measurement, which has been introduced into the inner peripheral side, passes through the flow paths in the various layers that are provided in the axial direction, to flow out to the outer peripheral side, where the fluid that is subject to measurement that flows out to the outer peripheral side merges to be supplied to the diaphragm.

### Method 2

### A Method Wherein the Fluid that is Subject to Measurement Passes from the Outer Peripheral Surface Side of the Baffle Structure to the Inner Peripheral Surface Side Thereof

In the second method, a baffle structure is provided wherein the fluid that is subject to measurement is introduced into the outer peripheral side, and this fluid that is subject to measurement, which has been introduced into the outer peripheral side, passes through the flow paths in the various layers that are provided in the axial direction, to flow out from the inner peripheral side, where the fluid that is subject to measurement that flows out from the inner peripheral side merges to be supplied to the diaphragm.

Moreover, in the present invention, the plurality of flow paths provided in the multiple layers that are provided in the axial direction of the baffle structure may be formed extending in parallel to the pressure-bearing surface of the diaphragm, and in the radial direction from the center of the cylindrical structure. In this case, the widths of the flow paths may gradually narrow from the outer peripheral side towards the inner peripheral side, or may be straight lines that are formed within planes that are parallel to the pressure bearing surface of the diaphragm, or the shape within the plane that is parallel to the pressure-bearing surface of the diaphragm may be non-linear (for example, a saw tooth shape (a lightning bolt shape or a zigzag shape), a spiral shape, or the like).

When the method for providing the baffle structure is of the second method, described above, then if the widths of the flow paths that extend in the radial direction become gradually narrower from the outer peripheral side toward the inner peripheral side, then the flow path will be wider at the inlet side wherein the consistency of active molecules that adhere readily will be high, and the flow path will narrow toward the outlet side as the consistency of molecules is gradually reduced, so as to have the effect of causing the adhesion of the molecules to the wall surfaces to be equalized, making it possible to increase the time between maintenance for handling blockage of flow paths.

Moreover, in the present invention, the plurality of flow paths provided in multiple layers in the axial direction of the baffle structure may be formed from slits that are provided in parallel with the pressure bearing surface of the diaphragm, from the spaces between obstacles that are provided within the slits. That is, in the present invention each of the pluralities of flow paths provided in the multiple layers that are provided in the axial direction of the baffle structure is not a single independent flow path, but rather includes also, for example, flow paths that are labyrinthine, converging and branching repetitively along the way.

In the present invention, the baffle structure is a cylindrical structure that is closed on one end, where a plurality of flow paths that pass between the inner peripheral surface and the outer peripheral surface of the cylindrical structure are provided in multiple layers in the axial direction, and the fluid that is subject to measurement flows through the plurality of flow paths that are provided in the multiple layers in the axial direction, thus causing the overall conductance to be high and mitigating the constraints on the design, while promoting adhesion of the contaminating substances within the flow paths without a loss in immediacy of the response speed of the sensor due to narrower and more complex flow paths.

### BRIEF DESCRIPTIONS OF THE DRAWINGS

FIG. 1 is a longitudinal-sectional diagram illustrating the critical portions of Example of an electrostatic capacitive pressure sensor according to the present disclosure.

FIG. 2 is a diagram illustrating the positional relationship between the inlet hole formed in the first pedestal plate and the outlet hole formed in the second pedestal plate in this electrostatic capacitive pressure sensor (diaphragm vacuum gauge).

FIG. 3 is a diagram illustrating a fundamental structure for a baffle structure used in a diaphragm vacuum gauge according to the Example.

FIG. 4 is a diagram wherein the longitudinal-sectional diagram of the diaphragm vacuum gauge of FIG. 1 is viewed obliquely from above.

FIG. 5 is a plan view diagram, viewed from the top plate side of the flow channel forming plates that structure a baffle structure used in a diaphragm vacuum gauge according to the Example, and an enlarged diagram of a flow channel that is formed in the flow channel forming plates.

FIG. 6 is a diagram illustrating the validation results for the slowing of the response speed of the sensor when the baffle structure is used.

FIG. 7 is a diagram illustrating another fundamental structure for a baffle structure used in a diaphragm vacuum gauge according to the Example.

FIG. 8 is a longitudinal-sectional diagram illustrating the critical portions of Another Example of an electrostatic capacitive pressure sensor according to the present disclosure.

FIG. 9 is a diagram illustrating a fundamental structure for a baffle structure used in a diaphragm vacuum gauge according to the Another Example.

FIG. 10 is a diagram wherein the longitudinal-sectional diagram of the diaphragm vacuum gauge of FIG. 8 is viewed obliquely from above.

FIG. 11 is a plan view diagram, viewed from the base plate side of the flow channel forming plates that structure a baffle structure used in a diaphragm vacuum gauge according to the Another Example, and an enlarged diagram of a flow channel that is formed in the flow channel forming plates.

FIG. 12 is a diagram illustrating another fundamental structure for a baffle structure used in a diaphragm vacuum gauge according to the Another Example.

FIG. 13 is a diagram illustrating one example wherein the shape of the channels (flow channels) that extend radially from the axis of the baffle structure are non-linear (a spiral shape).

FIG. 14 is a diagram illustrating another example wherein the shape of the channels (flow channels) that extend radially from the axis of the baffle structure are non-linear (a saw tooth shape).

FIG. 15 is a diagram illustrating an example wherein a plurality of circular column-shaped protrusions is provided as obstructions on a flow path forming plate.

FIG. 16 is a diagram illustrating a baffle attaching structure (a standard baffle) in a conventional diaphragm vacuum gauge.

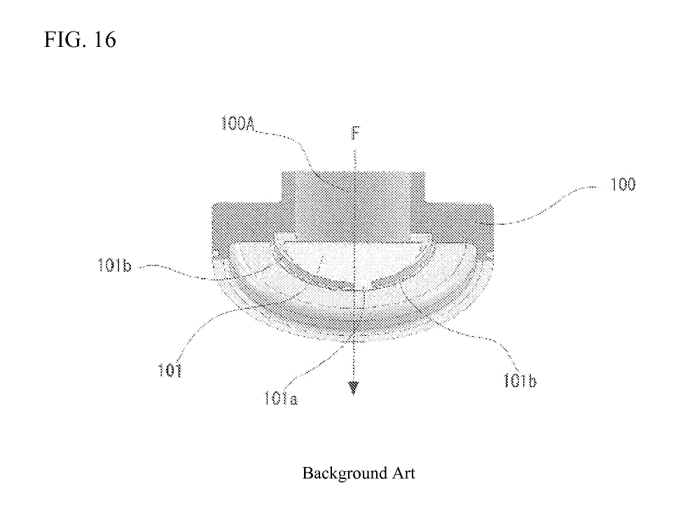

FIG. 17 is a diagram (a longitudinal-sectional diagram of a half-unit of a sensor) illustrating a baffle attaching structure in the diaphragm vacuum gauge illustrated in the JP '946.

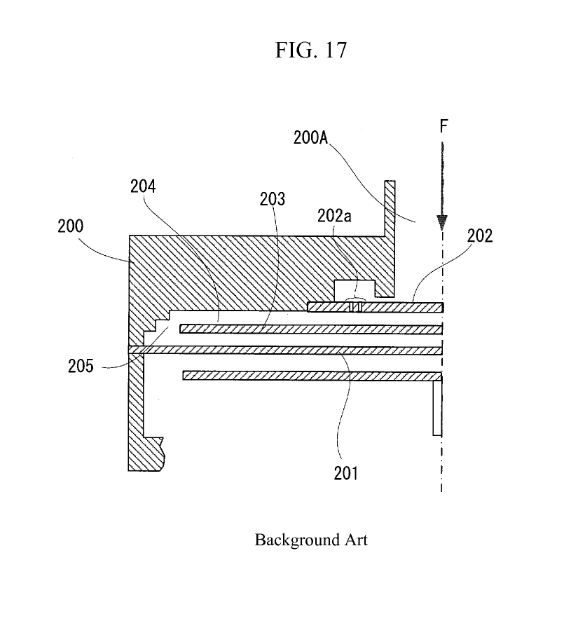

### DETAILED DESCRIPTION

The present disclosure will be explained in detail below based on the drawings.

### Example

### Method 1 (A Method Wherein the Fluid that is Subject to Measurement Passes from the Inner Peripheral Surface Side of the Baffle Structure to the Outer Peripheral Surface Side Thereof)

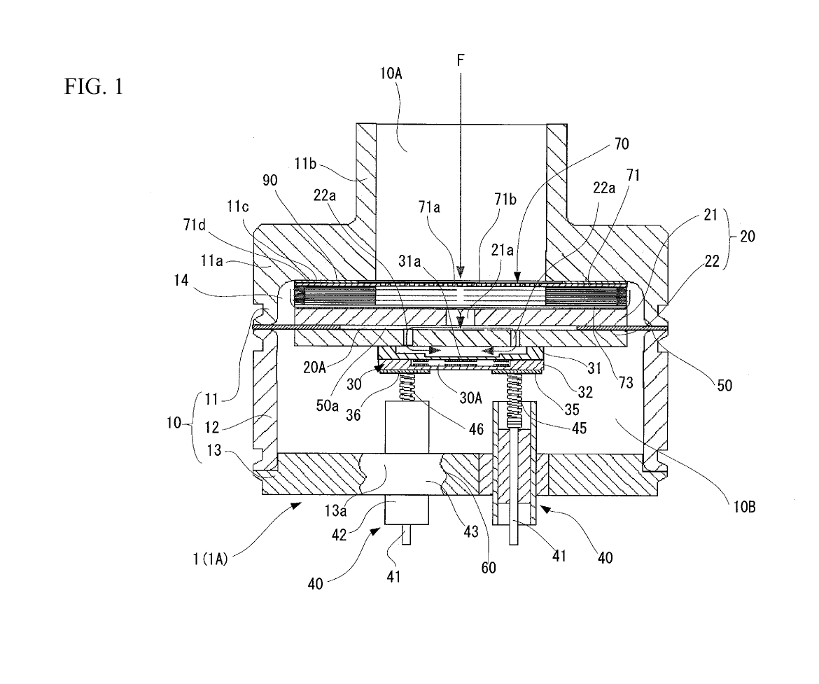

FIG. 1 is a longitudinal-sectional diagram illustrating the critical portions of the Example of an electrostatic capacitive pressure sensor (the Example) according to the present disclosure.

The electrostatic capacitive pressure sensor (diaphragm vacuum gauge) 1 (1A) includes: a package 10, a pedestal plate 20 that is contained within the package 10, a sensor chip 30 that is connected to the pedestal plate 20, similarly within the package 10, and an electrode lead portion 40 for connecting conductively to the outside of the package 10, connected directly to the package 10. Moreover, the pedestal plate 20 is structured from a first pedestal plate 21 and a second pedestal plate 22, separated from the package 10, supported on the package 10 only through a support diaphragm 50.

The package 10 is structured from an upper housing 11, a lower housing 12, and a cover 13. Note that the upper housing 11, the lower housing 12, and the cover 13 are made from inconel, which is a corrosion-resistant metal, and are joined together through welding.

The upper housing 11 is provided with a shape that connects cylindrical members having different diameters, where a large diameter portion 11a thereof has a portion that connects to a support diaphragm 50, and a small diameter portion 11b thereof forms a inlet portion 10A into which the fluid to be measured flows.

The lower housing 12 has an essentially cylindrical shape, and forms a reference vacuum chamber 10B for an independent vacuum chamber within the package 10, through the cover 13, the support diaphragm 50, the pedestal plate 20, and the sensor chip 30. Note that a gas adsorbing substance, known as a getter (not shown), is disposed in the reference vacuum chamber 10B, to maintain the vacuum level.

Moreover, the cover 13 is made from a circular plate, where an electrode lead through hole 13a is formed in a specific location of the cover 13, and an electrode lead portion 40 is buried by a hermetic seal 60, where the seal performance of this portion is ensured thereby.

On the other hand, a support diaphragm 50 is made from a thin plate of inconel that has an exterior shape matching the shape of the package 10, with the outer peripheral portion (the peripheral edge portion) thereof bonded through welding, or the like, between the edge portions of the upper housing 11 and the lower housing 12, in a state wherein it is interposed between the first pedestal plate 21 and the second pedestal plate 22.

The thickness of the support diaphragm 50 is, in the case of the present example, for example, several tens of micrometers, and is sufficiently thinner than each of the pedestal plates 21 and 22. Moreover, a large-diameter hole 50a that forms a slit-shaped space (a cavity) 20A is formed between the first pedestal plate 21 and the second pedestal plate 22 in the center portion of the support diaphragm 50.

The first pedestal plate 21 and the second pedestal plate 22 are made from sapphire, which is single crystal aluminum oxide, where the first pedestal plate 21 is bonded to the top surface of the support diaphragm 50 in a state wherein it is separated from the inner surface of the package 10, and the second pedestal plate 22 is bonded to the bottom surface of the support diaphragm 50 in a state wherein it is separated from the inner surface of the package 10.

Moreover, an inlet hole 21a for the fluid that is subject to measurement that passes through the slit-shaped space (the cavity) 20A is formed in the center portion of the first pedestal plate 21, and a plurality (which, in the present example, 4) of outlet holes 22a to the sensor diaphragm 31a of the sensor chip 30 is formed in communication with the slit-shaped space (the cavity) 20A in the second pedestal plate 22.

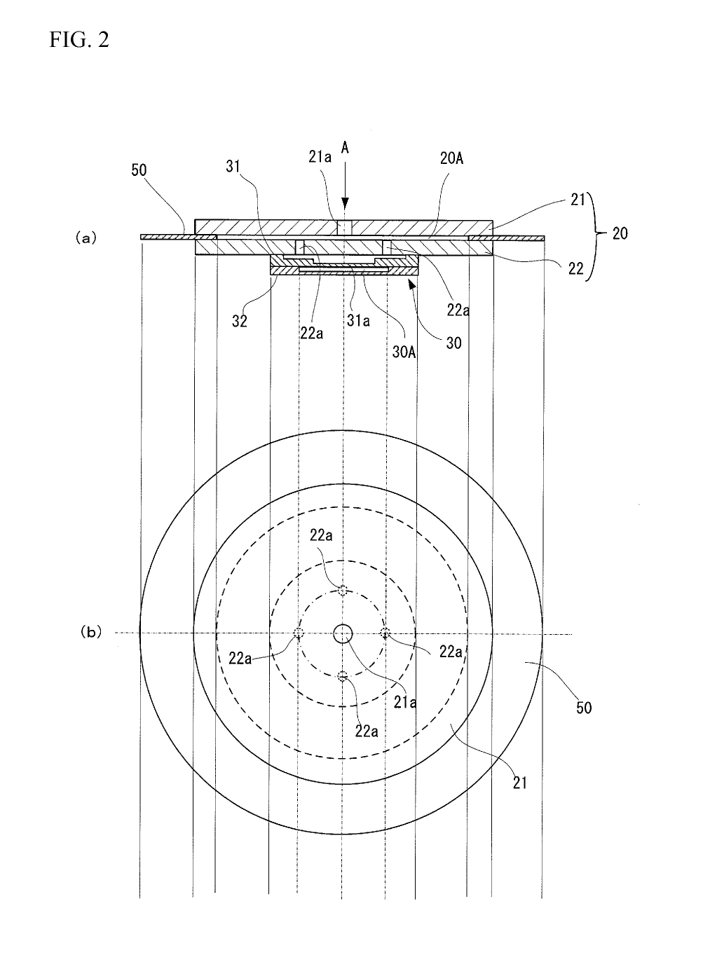

FIG. 2 is a diagram illustrating the positional relationship between the inlet hole 21a formed in the first pedestal plate 21 and the outlet hole 22a formed in the second pedestal plate 22. FIG. 2 (a) is a diagram showing extracts of the critical portions from FIG. 1 (a longitudinal-sectional diagram), and FIG. 2 (b) is a plan view diagram when FIG. 2 (a) is viewed in the direction of the arrow A.

As illustrated in FIG. 2, the inlet hole 21a of the first pedestal plate 21 and the outlet holes 22a of the second pedestal plate 22 are provided in locations that do not overlap in the direction of thickness of the first pedestal plate 21 and the second pedestal plate 22.

In the present example, one inlet hole 21a is provided in the center portion of the first pedestal plate 21, and four outlet holes 22a are provided in the peripheral edge portion of the second pedestal plate 22, separated, in the radial direction, from the center of the second pedestal plate 22, and with equal spacing in the circumferential direction.

Note that the individual pedestal plates 21 and 22 are adequately thick, as described above, relative to the thickness of the support diaphragm 50, and are structured so as to hold the support diaphragm 50 in a so-called “sandwich shape” between the two pedestal plates 21 and 22. Doing so prevents warping of this part due to thermal stresses that are produced through a difference in the coefficients of thermal expansion of the pedestal plate 20 and the support diaphragm 50.

Additionally, the sensor chip 30, made from sapphire, which is a single-crystal aluminum oxide crystal, and having a square shape when viewed from above, is bonded to the second pedestal plate 22, through a bonding material of an aluminum oxide base. Note that the method for attaching the sensor chip 30 is disclosed in detail in Japanese Unexamined Patent Application Publication No. 2002-111011, so detailed explanations thereof are omitted here.

The sensor chip 30 includes a sensor plate 31, made out of a thin plate that has a square shape, when viewed from above, with a size of no more than 1 cm², and a sensor pedestal 32 that forms a vacuum capacitor chamber (a reference chamber) 30A through being bonded to the sensor plate 31. The center portion of the sensor plate 31 is in the form of a thin film, where this center portion of the sensor plate 31 that is in the form of a thin film is used as the sensor diaphragm 31a that undergoes deformation in response to the application of a pressure. Additionally, the vacuum capacitance chamber 30A and the reference vacuum chamber 10B maintain identical vacuum levels for both through a connecting hole, not shown, penetrating through an appropriate location of the sensor pedestal 32.

Note that the sensor plate 31 and the sensor pedestal 32 are bonded to each other through so-called direct bonding, to structure an integrated sensor chip 30. The sensor diaphragm 31a, which is a structural element of this sensor chip 30, corresponds to the “diaphragm” in the present invention.

Moreover, stationary electrodes are formed out of a conductor such as gold or platinum, or the like, on a recessed portion of the sensor pedestal 32, and movable electrodes are formed out of a conductor such as gold, platinum, or the like, on the front face of the sensor diaphragm 31a, which faces the stationary electrodes, in the capacitance chamber 30A of the sensor chip 30. Moreover, contact pads 35 and 36 are formed from gold or platinum on the top face of the sensor chip 30, and the stationary electrodes and the movable electrodes are connected by interconnections, not shown, to the contact pads 35 and 36 within the sensor chip 30.

On the other hand, the electrode lead portions 40 are provided with electrode lead pins 41 and metal shields 42, where the electrode lead pins 41 are embedded in the center part through hermetic sealing 43, made from an insulating material such as glass, on the metal shield 42, to maintain an airtight state between the two end portions of each electrode lead pin 41. Additionally, one end of each electrode lead pin 41 is exposed to the outside of the package 10, and the output of the diaphragm vacuum gauge 1 propagates to an external signal processing portion through an interconnection, not shown. Note that, as described above, the hermetic seal 43 is interposed between the shield 42 and the cover 13. Contact springs 45 and 46, which are electrically conductive, are connected to the other end of the electrode lead pin 41.

The contact springs 45 and 46 have adequate flexibility so that even if the support diaphragm 50 were to be dislocated slightly through a violent increase in pressure through a sudden inflow of the fluid to be measured from the inlet portion 10A, still the biasing force of the contact springs 45 and 46 would prevent a negative impact on the measurement accuracy of the sensor chip 30.

In this diaphragm vacuum gauge 1, a round cylindrical baffle structure 70 that is closed on one end (the bottom end) is disposed between the inlet portion 10A of the upper diaphragm 10 and the pedestal plate 20, with the direction that is perpendicular to the pressure-bearing surface of the sensor diaphragm 31a as the axial direction thereof.

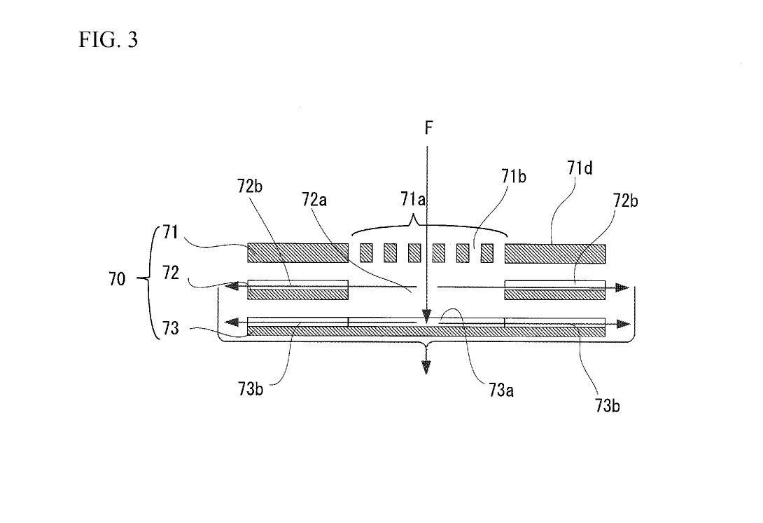

FIG. 3 illustrates the fundamental structure of the baffle structure 70. This baffle structure 70 is provided with a top plate 71 that has, in the center portion of the plate surface thereof, an inlet hole 71a for directing the fluid that is subject to measurement that is supplied from the inlet portion 10A of the upper housing 11, a flow path forming plate 72 that has, in the center portion of the plate surface thereof, an inlet hole 72a for directing the fluid that is subject to measurement, supplied through the inlet hole 71a of the top plate 71, and a base plate 73 that has a plate surface that closes the end surface of the flow path forming plate 72 on the sensor diaphragm 31a side, where multiple flow path forming plates 72 are stacked between the top plate 71 and the base plate 73, where the top plate 71, the flow path forming plates 72, and the base plate 73 have the respective surfaces thereof brought together and bonded (through heat and pressure).

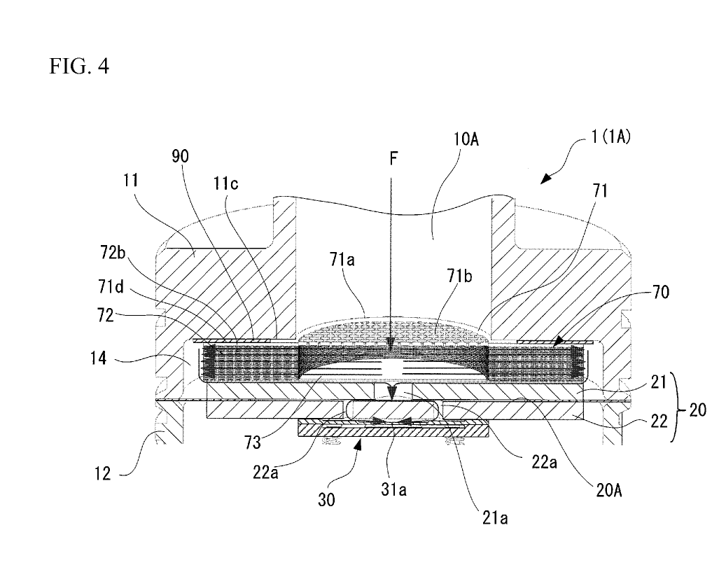

In the baffle structure 70, the top plate 71, the flow path forming plate 72, and the base plate 73 are formed from inconel, and they have identical outer diameters. FIG. 4 is a diagram wherein the longitudinal-sectional diagram of the diaphragm vacuum gauge 1 (1A) of FIG. 1 is viewed obliquely from above. The opening portion of the inlet hole 71a of the top plate 71 is divided into a plurality of holes (round holes) 71b.

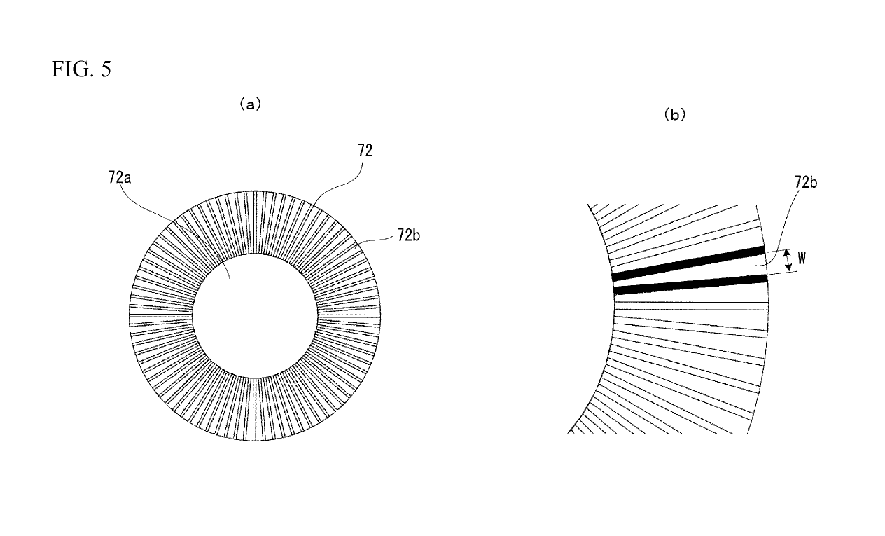

The inlet hole 72a of the flow path forming plate 72 corresponds to the inlet hole 71a of the top plate 71, and is a round hole having the same diameter as this inlet hole 71a. FIG. 5 (a) shows a plan view diagram of the flow path forming plate 72 when viewed from the top plate 71 side.

A plurality of flow path channels 72b that extend in the radial direction are formed on the plate surface of the top plate 71 side of the flow path forming plate 72, extending in parallel to the pressure bearing surface of the sensor diaphragm 31a, and radially from the center of the baffle structure (the round cylindrical structure) 70. These flow path channels 72b, as illustrated in FIG. 5 (b) wherein both walls for a single flow path channel 72b are shown filled in black, have a width W that gradually narrows toward the inner peripheral side from the outer peripheral side. Moreover, these flow path channels 72b are shaped as straight lines within a plane that is parallel to the pressure bearing surface of the sensor diaphragm 31a.

As with the flow path forming plate 72, a plurality of flow path channels 73b is formed in the base plate 73 as well, extending within the plane of the top plate 71, in a radial shape from the center of the baffle structure (the round cylindrical structure) 70. However, no inlet holes are formed in the center portion 73a of the base plate 73, but rather it is closed with no fluid that is subject to measurement passing therethrough.

With the baffle structure 70 in a state that is disposed between the inlet portion 10A and the pedestal plate 20, the inlet hole 71a of the top plate 71 surfaces the inlet portion 10A, where the outer peripheral edge surface 71d of the inlet hole 71a is in intimate contact with an inner step surface 11c of an upper housing 11 through a ring-shaped partitioning plate 90. In this state, the fluid that is subject to measurement, from the inlet portion 10A, passes through only the inlet hole 71a, and does not pass between the outer peripheral edge surface 71d of the inlet hole 71a and the inner step surface 11c of the upper housing 11.

Moreover, with the baffle structure 70 between the inlet portion 10A and the pedestal plate 20, the outer peripheral edge surfaces of the top plate 71, the flow path forming plates 72, and the base plate 73, that is, the outer peripheral surface of the baffle structure 70, are positioned in a sealed space 14 surrounded by the upper housing 11 and the support diaphragm 50. Moreover, a gap wherein the fluid that is subject to measurement flows is provided between the plate surface of the base plate 73 on the sensor diaphragm 31a side and the pedestal plate 20 (the first pedestal plate 21).

Moreover, in the present example, the width and height of the flow path channel 72b that is provided in the flow path forming plate 72, and of the flow path channel 73b that is provided in the base plate 73 are of a width and a height that will cause the flow of the fluid that is subject to measurement to be a molecular flow. In this example, the width and the height of the flow path channels 72b and 73b are between about 10 and 200 μm. Moreover, the lengths of the flow path channels 72b and 73b (the lengths in the direction of flow of the fluid that is subject to measurement) are between about 3 and 20 mm. Furthermore, the flow path channels 72b and 73b are formed through half-etching.

The operation of the diaphragm vacuum gauge (1A) according to the Example will be explained next. Note that in the Example, the diaphragm vacuum gauge 1 (1A) is attached to the necessary location in an ALD film deposition process.

Measuring the Pressure of the Fluid that is Subject to Measurement

In this diaphragm vacuum gauge 1 (1A), the fluid that is subject to measurement (a gas) arrives at the sensor diaphragm 31a from the inlet portion 10A, and the sensor diaphragm 31a deforms due to the pressure difference between the pressure of the fluid that is subject to measurement and that of the vacuum capacitance chamber 30A, changing the gap between the stationary electrode and the movable electrode that are provided between the back surface of the sensor diaphragm 31a and the inner surface of the sensor pedestal 32, causing a change in the capacitance value (the electrostatic capacitance) of the capacitor that is formed by the stationary electrode and the movable electrode. The change in the electrostatic capacitance is led out to the outside of the diaphragm vacuum gauge, and the pressure of the fluid that is subject to measurement is measured thereby.

### Preventing Deposition of Contaminating Substances

When measuring the pressure, the fluid that is subject to measurement (a gas) from the inlet portion 10A passes through the baffle structure 70. In this case, the fluid that is subject to measurement (the gas) from the inlet portion 10A passes through the baffle structure 70 from the inner peripheral surface side thereof to the outer peripheral surface side thereof, and merges and is provided to the sensor diaphragm 31a.

That is, the fluid that is subject to measurement, from the inlet portion 10A, passes through the plurality of holes 71b into which the inlet hole 71a of the top plate 71 is divided, and is directed to the inner peripheral surface side of the baffle structure 70. This fluid that is subject to measurement, which has been introduced to the inner peripheral surface side, enters into the flow path channels 72b of the various flow path forming plates 72 that are stacked in the axial direction of the baffle structure 70, and into the flow path channels 73b of the base plate 73, to pass through these flow path channels 72b and 73b, to flow out to the outer peripheral surface side of the baffle structure 70.

Given this, the fluid that is subject to measurement, which has flowed out of the outer peripheral surface side of the baffle structure 70, merges and passes through the gap between the base plate 73 and the first pedestal plate 21, to enter into the slit-shaped space (the cavity) 20A between the first pedestal plate 21 and the second pedestal plate 22 through the inlet hole 21a of the first pedestal plate 21, to exit through the outlet hole 22a of the second pedestal plate 22, to arrive at the sensor diaphragm 31a of the sensor chip 30.

In the baffle structure 70, the flow path channels 72b and 73b are provided so as to extend in parallel to the pressure-bearing surface of the sensor diaphragm 31a, radiating from the center of the baffle structure (the round cylindrical structure) 70 (as flow paths that pass between the inner peripheral surface side and the outer peripheral surface side of the baffle structure 70), where the flow paths that extend radially are formed in multiple layers in the axial direction of the baffle structure 70. The fluid that is subject to measurement flows through the radial flow paths that are provided in multiple layers in the axial direction of the baffle structure 70.

In the baffle structure 70, the widths and heights of the flow path channels 72b and 73b are between about 10 and 200 μm, so the conductance of a single flow path is extremely small. That is, the width and height of a single flow path is made small enough that the flow of the fluid that is subject to measurement will be a molecular flow, promoting adhesion of the contaminating substances. Because of this, the conductance of a single flow path will be extremely small. However, in the present example a plurality of these flow paths is provided, and, further, pluralities of flow paths are provided in multiple layers in the axial direction, to cause the overall conductance to be large. The spacer possible to relax the constraints in design and to promote the adhesion of contaminating substances within the flow path without a loss of immediacy in the response speed of the sensor through making the flow path narrower and more complex.

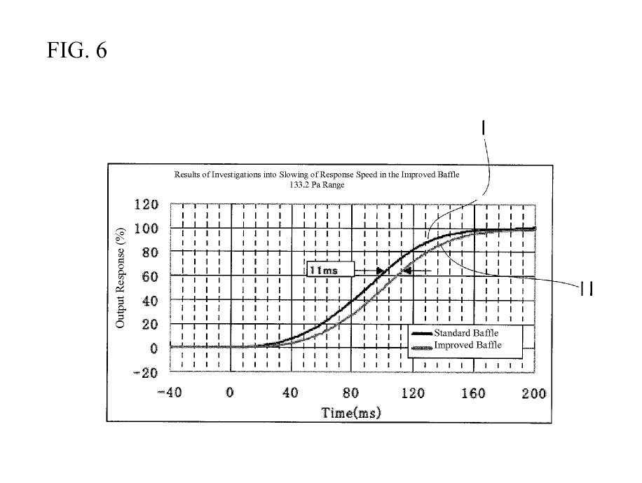

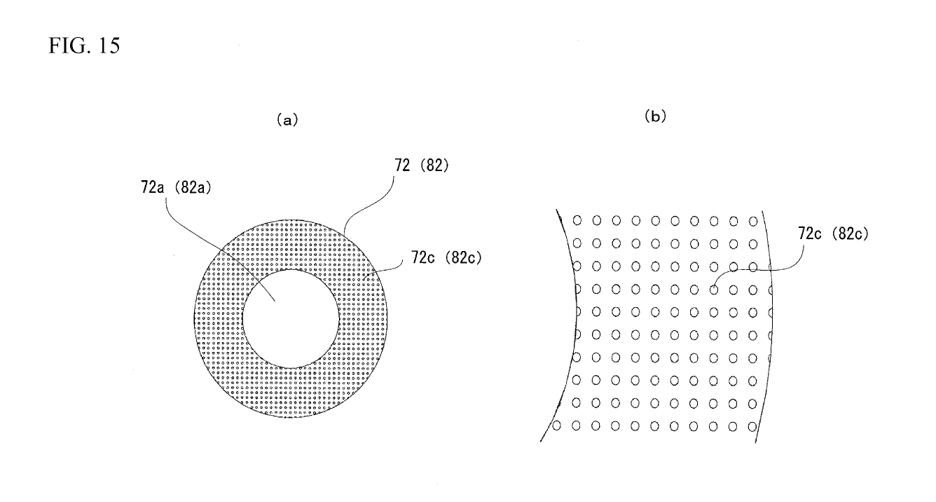

FIG. 6 illustrates the validation results for the slowing of the response speed of the sensor when the baffle structure 70 is used. In FIG. 6, curve I is the output response curve for the sensor when a standard baffle, illustrated in FIG. 15, is used, and curve II is the output response curve for a sensor when the baffle structure 70 (the improved baffle) is used. In contrast to the output response curve I of the sensor when the standard baffle is used, the delay in the output response curve II for the sensor when the baffle structure 70 is used is small. In this case, the greater the number of flow path forming plates 72 between the top plate 71 and the base plate 73, that is, the higher the adhesion efficiency of the contaminating substances within the flow paths, the mirror to the output response curve I for the sensor when the standard baffle is used.

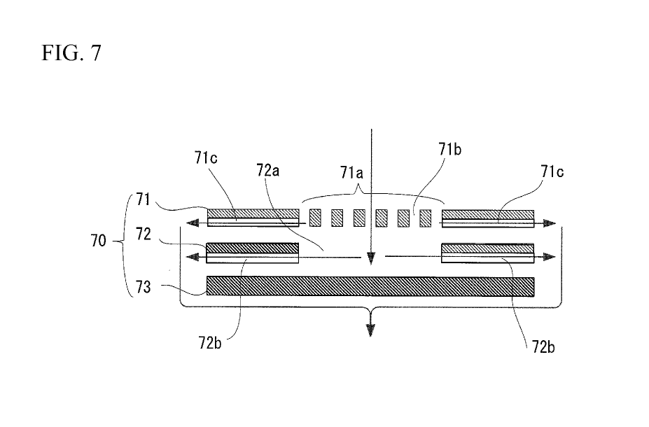

Note that while in the present example flow path channels 73b are provided in the base plate 73 (FIG. 3), conversely flow path channels 71c may be provided in the top plate 71, as illustrated in FIG. 7. In this case, the flow path channels 71c of the top plate 71 are provided on the plate surface on the base plate 73 side. Moreover, the flow path channels 72b of the flow path forming plate 72 are also provided on the plate surface on the base plate 73 side.

Because, with the structure illustrated in FIG. 3, the flow path channels 73b of the base plate 73 are added to the flow path channels 72b of the flow path forming plates 72, multilayer flow path channels are formed, and with the structure illustrated in FIG. 7, the flow path channels 71c of the top plate 71 are added to the flow path channels 72b of the flow path forming plate 72, forming multiple layers of flow path channels, and thus even if only a single flow path forming plate 72 is interposed between the top plate 71 and the base plate 73, still this forms the fundamental structure of the baffle structure 70 (a structure wherein pluralities of flow paths are provided in multiple layers).

Note that the flow path channels need not necessarily be formed in the top plate 71 and the base plate 73, and if the flow path channels are formed in neither the top plate 71 nor the base plate 73, then the basic structure of the baffle structure 70 is one wherein there are two flow path forming plates 72 between the top plate 71 and the base plate 73.

In this Example, the fundamental structure of the baffle structure 70, set forth above, is the minimum structure, and by setting the number of flow path forming plates 72 between the top plate 71 and the base plate 73 appropriately, a desirable baffle structure 70 with a high efficiency of adhesion of the contaminating substances to the inside of the flow paths, without a loss of immediacy of the response speed of the sensor, can be produced. In this case, the flow path forming plates 72 are identical components, making it possible to produce the required baffle structure 70 by merely adjusting the number of flow path forming plates 72.

### Another Example

### Method 2 (A Method Wherein the Fluid that is Subject to Measurement Passes from the Outer Peripheral Surface Side of the Baffle Structure to the Inner Peripheral Surface Side Thereof)

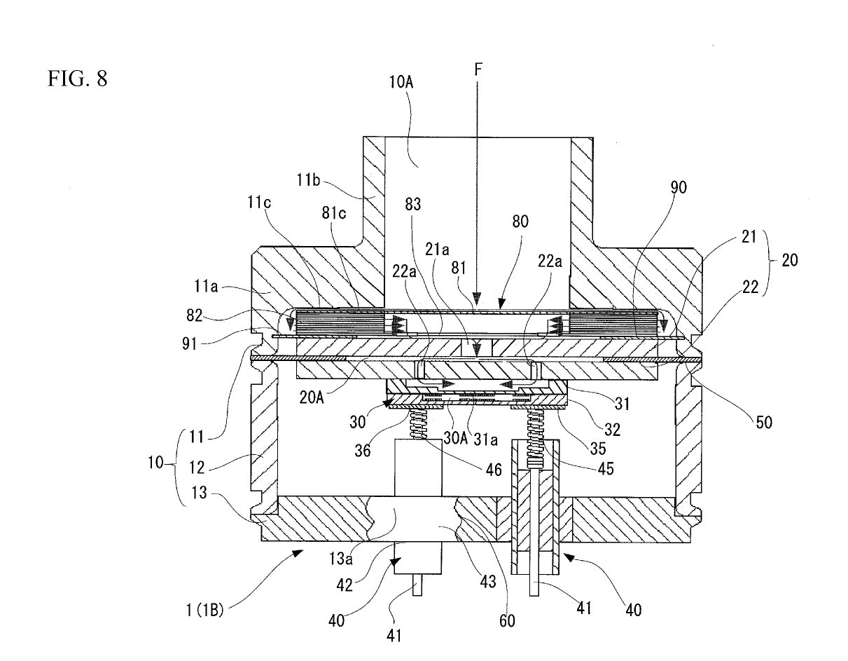

FIG. 8 is a longitudinal-sectional diagram illustrating the critical portions of Another Example of an electrostatic capacitive pressure sensor according to the present disclosure. In this figure, codes that are the same as those in FIG. 1 indicate identical or equivalent structural elements as the structural elements explained in reference to FIG. 1, and explanations thereof are omitted.

In this electrostatic capacitive pressure sensor (diaphragm vacuum gauge) 1 (1B), a round cylindrical baffle structure 80 that is closed on one end (the top end) is disposed between the inlet portion 10A of the upper diaphragm 10 and the pedestal plate 20, with the direction that is perpendicular to the pressure-bearing surface of the sensor diaphragm 31a as the axial direction thereof.

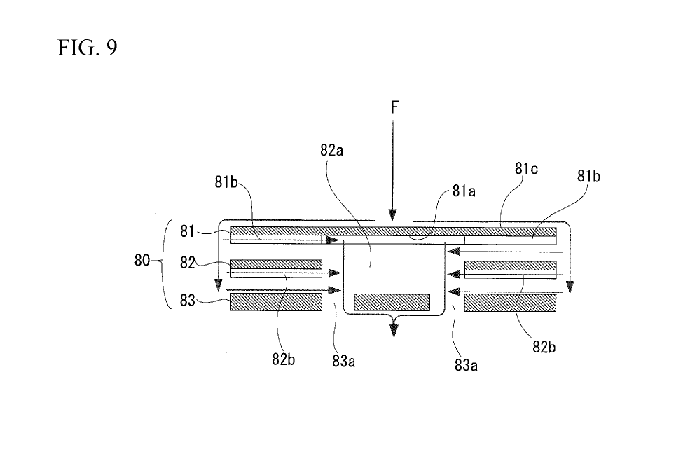

FIG. 9 illustrates the fundamental structure of the baffle structure 80. This baffle structure 80 is provided with a top plate 81 that has a plate surface that is closed so that the fluid that is subject to measurement that is supplied from the inlet portion 10A of the upper housing 11 does not pass through the plate surface, a flow path forming plate 82 that has, in the center portion of the plate surface thereof, an inlet hole 82a for the fluid that is subject to measurement, and a base plate 83 that has, in the plate surface thereof, an inlet opening 83a for directing, to the sensor diaphragm 31a side, the fluid that is subject to measurement, which is supplied through the inlet hole 82a of the flow path forming plate 82, where multiple flow path forming plates 82 are stacked between the top plate 81 and the base plate 83, where the top plate 81, the flow path forming plates 82, and the base plate 83 have the respective surfaces thereof brought together and bonded (through heat and pressure).

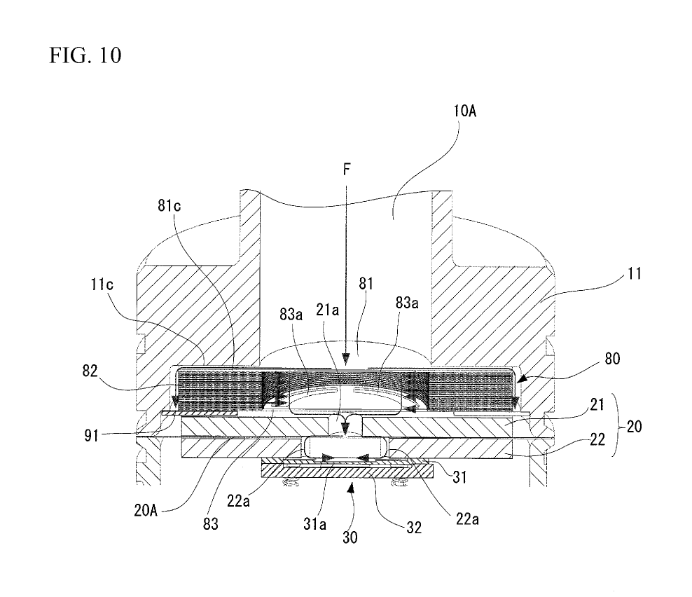

In the baffle structure 80, the top plate 81, the flow path forming plate 82, and the base plate 83 are formed from inconel, and they have identical outer diameters. FIG. 10 is a diagram wherein the longitudinal-sectional diagram of the diaphragm vacuum gauge 81 (1B) of FIG. 18 is viewed obliquely from above. The top surface of the top plate 81 (the closed surface) faces the inlet portion 10A.

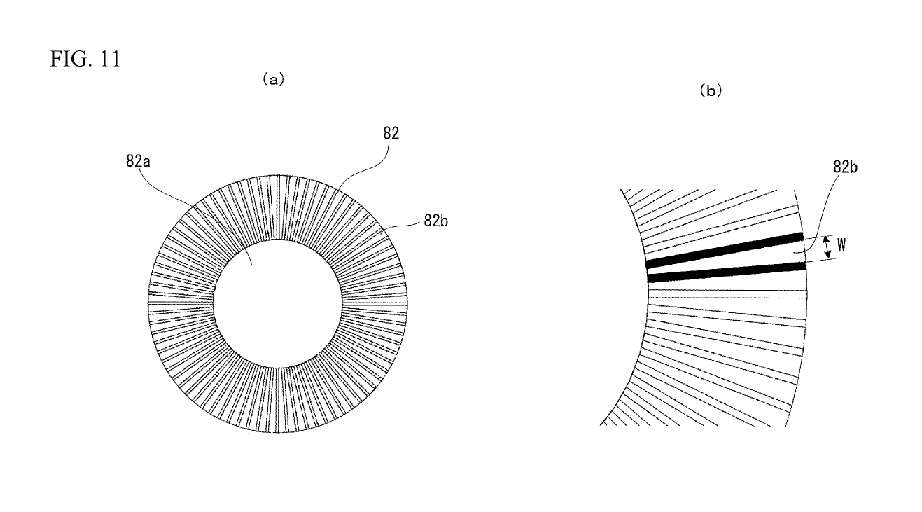

The inlet hole 82a of the flow path forming plate 82 corresponds to the opening of the inlet portion 10A, and is a round hole having the same diameter as this opening. FIG. 11 (a) shows a plan view diagram of the flow path forming plate 82 when viewed from the base plate 83 side. A plurality of flow path channels 82b that extend in the radial direction are formed on the plate surface of the base plate 83 side of the flow path forming plate 82, extending in parallel to the pressure bearing surface of the sensor diaphragm 31a, and radially from the center of the baffle structure (the round cylindrical structure) 80. These flow path channels 82b, as illustrated in FIG. 11 (b) wherein both walls for a single flow path channel 82b are shown filled in black, have a width W that gradually narrows toward the inner peripheral side from the outer peripheral side. Moreover, these flow path channels 82b are shaped as straight lines within a plane that is parallel to the pressure bearing surface of the sensor diaphragm 31a.

As with the flow path forming plate 82, a plurality of flow path channels 81b is formed in the top plate 81 as well, extending within the plane of the base plate 83, in a radial shape from the center of the baffle structure (the round cylindrical structure) 80. However, no inlet holes are formed in the center portion 81a of the top plate 81, but rather it is closed with no fluid that is subject to measurement passing therethrough.

A plurality of inlet holes 83a are formed in the peripheral edge portion of the surface of the base plate 83 corresponding to the inlet holes 82a of the flow path forming plate 82, where the inlet holes 83a are circular arc-shaped long round holes.

With the baffle structure 80 between the inlet portion 10A and the pedestal plate 20, a gap through which the fluid to be measured flows is provided between the peripheral edge surface 81c of the top plate 81 and an inner step surface 11c of the upper housing 11.

Moreover, the base plate 83 is in tight contact with a pedestal plate 20 (the first pedestal plate 21) through a ring-shaped partitioning plate 91, and in this state, the fluid that is subject to measurement, which flows into the outer peripheral surface side of the baffle structure 80 through the gap between the outer peripheral edge surface 81c of the top plate 81 and the inner step surface 11c of the upper housing 11, does not pass between the base plate 83 and the pedestal plate 20 (the first pedestal plate 21).

Moreover, in the present example, the width and height of the flow path channel 81b that is provided in the top plate 81, and of the flow path channel 82b that is provided in the flow path forming plate 82 are of a width and a height that will cause the flow of the fluid that is subject to measurement to be a molecular flow. In this example, the width and the height of the flow path channels 81b and 82b are between about 10 and 200 μm. Moreover, the lengths of the flow path channels 81b and 82b (the lengths in the direction of flow of the fluid that is subject to measurement) are between about 3 and 20 mm. Furthermore, the flow path channels 81b and 82b are formed through half-etching.

### Preventing Deposition of Contaminating Substances

When measuring the pressure in the diaphragm vacuum gauge 1 (1B) of the Another Example as well, the fluid that is subject to measurement (a gas) from the inlet portion 10A passes through the baffle structure 80. In this case, the fluid that is subject to measurement (the gas) from the inlet portion 10A passes through the baffle structure 80 from the outer peripheral surface side thereof to the inner peripheral surface side thereof, and merges and is provided to the sensor diaphragm 31a.

That is, the fluid that is subject to measurement, from the inlet portion 10A, strikes the plate surface of the top plate 81 that is closed, and is redirected by this closed plate surface to flow through the gap between the outer peripheral edge surface 81c of the top plate 81 and the inner step surface 11c of the upper housing 11, to be supplied to the outer peripheral surface side of the baffle structure 80.

This fluid that is subject to measurement, which has been introduced to the outer peripheral surface side, enters into the flow path channels 81b of the top plates 81 and into the flow path channels 82b of various flow path forming plates 82 that are stacked in the axial direction of the baffle structure 80, to pass through these flow path channels 81b and 82b, to flow out of the inner peripheral surface side of the baffle structure 80.

Given this, the fluid that is subject to measurement, which has flowed out of the inner peripheral surface side of the baffle structure 80, merges and passes through the inlet hole 83a of the base plate 83, to enter into the slit-shaped space (the cavity) 20A between the first pedestal plate 21 and the second pedestal plate 22 through the inlet hole 21a of the first pedestal plate 21, to exit through the outlet hole 22a of the second pedestal plate 22, to arrive at the sensor diaphragm 31a of the sensor chip 30.

In the baffle structure 80, the flow path channels 81b and 82b are provided so as to extend in parallel to the pressure-bearing surface of the sensor diaphragm 31a, radiating from the center of the baffle structure (the round cylindrical structure) 80 (as flow paths that pass between the inner peripheral surface side and the outer peripheral surface side of the baffle structure 80), where the flow paths that extend radially are formed in multiple layers in the axial direction of the baffle structure 80. The fluid that is subject to measurement flows through the radial flow paths that are provided in multiple layers in the axial direction of the baffle structure 80.

In the baffle structure 80, the widths and heights of the flow path channels 82b and 83b are between about 10 and 200 μm, so the conductance of a single flow path is extremely small. While because of this, in the same manner as with the baffle structure 70 of the first example, the conductance of a single flow path is extremely small, the overall conductance is made large through the provision of this flow path in a plurality, and through the provision of multiple layers, with these pluralities of flow paths, in the axial direction. The spacer possible to relax the constraints in design and to promote the adhesion of contaminating substances within the flow path without a loss of immediacy in the response speed of the sensor through making the flow path narrower and more complex.

In particular, in this baffle structure 80 the widths of the flow paths that extend in the radial direction become gradually narrower from the outer peripheral side toward the inner peripheral side, so the flow path will be wider at the inlet side wherein the consistency of active molecules that adhere readily will be high, and the flow path will narrow toward the outlet side as the consistency of molecules is gradually reduced, so as to have the effect of causing the adhesion of the molecules to the wall surfaces to be equalized, making it possible to increase the time between maintenance for handling blockage of flow paths. In the baffle structure 80 according to the Another Example, there is the beneficial effect of the widths of the flow paths that extend in the radial direction becoming gradually narrower from the outer peripheral side toward the inner peripheral side.

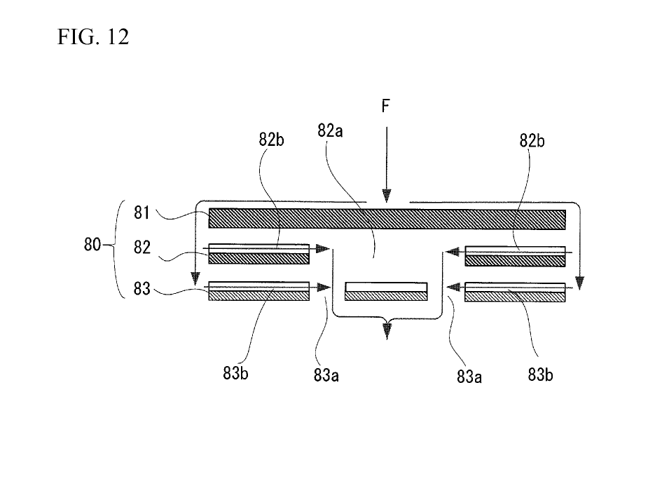

Note that while in the present example flow path channels 81b are provided in the top plate 81 (FIG. 9), conversely flow path channels 83b may be provided in the base plate 83, as illustrated in FIG. 12. In this case, the flow path channels 83b of the base plate 83 are provided on the plate surface on the top plate 81 side. Moreover, the flow path channels 82b of the flow path forming plate 82 are also provided on the plate surface on the top plate 81 side.

Because, with the structure illustrated in FIG. 9, the flow path channels 81b of the top plate 81 are added to the flow path channels 82b of the flow path forming plates 82, multilayer flow path channels are formed, and with the structure illustrated in FIG. 12, the flow path channels 83b of the base plate 83 are added to the flow path channels 82b of the flow path forming plate 82, forming multiple layers of flow path channels, and thus a structure wherein a single flow path forming plate 82 is interposed between the top plate 81 and the base plate 83 forms the fundamental structure of the baffle structure 80 (a structure wherein pluralities of flow paths are provided in multiple layers).

Note that the flow path channels need not necessarily be formed in the top plate 81 and the base plate 83, and if the flow path channels are formed in neither the top plate 81 nor the base plate 83, then the basic structure of the baffle structure 80 is a structure wherein there are two flow path forming plates 82 between the top plate 81 and the base plate 83.

In the Another Example, the fundamental structure of the baffle structure 80, set forth above, is the minimum structure, and by setting the number of flow path forming plates 82 between the top plate 81 and the base plate 83 appropriately, a desirable baffle structure 80 with a high efficiency of adhesion of the contaminating substances to the inside of the flow paths, without a loss of immediacy of the response speed of the sensor, can be produced. In this case, the flow path forming plates 82 are identical components, making it possible to produce the required baffle structure 80 by merely adjusting the number of flow path forming plates 82.

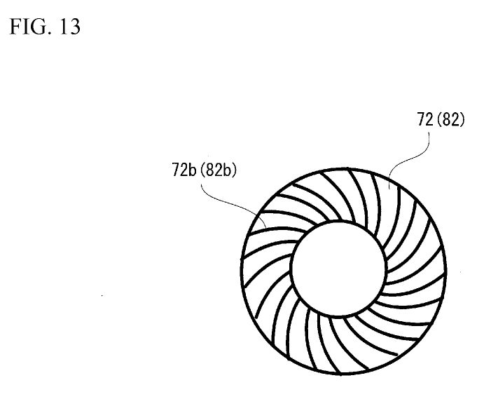

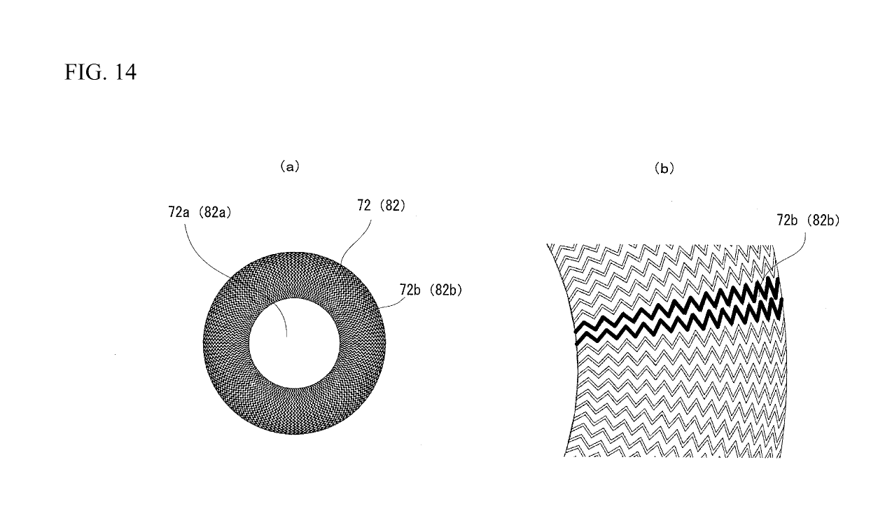

Note that while in the Example and the Another Example, set forth above, the shape of the flow paths that extend radially from the centers of the baffle structures 70 and 80 (the shapes that are within the planes that are parallel to the pressure-bearing surface of the sensor diaphragm 31a) were straight lines, they may be non-linear shapes instead. For example, various patterns may be considered, such as a non-linear shape that is a pattern that is bent into a spiral (referencing FIG. 13), a pattern that is bent into a saw tooth shape (a lightning bolt shape, a zigzag shape, or the like) (referencing FIG. 14), and so forth. Moreover, the width of the flow paths that extend radially from the centers of the baffle structures 70 and 80 need not necessarily become gradually narrower toward the inner periphery from the outer periphery, but rather may maintain uniform width.

Moreover, the plurality of flow path is provided in multiple layers in the axial direction of the baffle structures 70 and 80 may be slits that are provided in parallel to the pressure-bearing surface of the sensor diaphragm 31a, and may be formed from the spaces between obstacles that are provided within these slits. For example, as illustrated in FIG. 15, multiple round cylindrical protrusions 72c (82c) are provided as obstacles in the flow path forming plates 72 (82), and are converted into multiple flow paths through obstacles in the direction of flow of the fluid that is subject to measurement in the slits, between a flow path forming plate 72 (82) and the adjacent plate.

Note that the obstacles that are disposed within the slits are not limited to round cylindrical protrusions, but instead may be structures that are at an angle relative to the meridian of the flow path that is centered on the center of the baffle structure. A variety of shapes may be considered; for example, it may be a wedge shape, a “<” shape, a round shape, a fan shape, or the like. That is, the plurality of flow paths that are provided in multiple layers in the axial direction of the baffle structure 70 or 80 need not be only respectively independent single flow paths, but may instead be flow paths that are labyrinthine through repetitively merging and branching along the way.

Moreover, while in the Example and the Another Example the baffle structures were structures that had top plates, flow path forming plates, and bottom plates, the structure need not necessarily have such a layered plate structure. For example, the round cylindrical structure that is closed on one end may be a monolithic structure, where, within this monolithic structure, a plurality of horizontal holes that pass between the outer peripheral surface and the inner peripheral surface are provided in multiple layers in the axial direction. Moreover, the baffle structure need only be a cylindrical shape, and is not limited to being a circular cylindrical shape.

For reference, an example of setting the number of layers of flow paths will be given below.

(1) The response speed is defined as follows. In the case of a vacuum sensor, it is defined as the time for the sensor output to respond to 63% of the full scale P0 after first drawing a vacuum on the pressure-bearing surface and defining the sensor output as zero, and then introducing, from the sensor attaching portion, a gas at the full scale pressure (P0) of the measurement range. Response speeds that are typically required are roughly between 30 and 100 ms, in consideration of the responses of the measurement circuits.

(2) The volume (V) of the space in the baffle of the sensor pressure bearing portion, that is, of the space from the exit of the flow paths to the sensor diaphragm, is calculated or found experimentally.

(3) The conductance C per individual slit or individual fine hole is estimated through calculation.

(4) When a gas of the pressure P0 is provided through a plurality of n flow paths that are arranged in parallel, each having a conductance of C, to a space with a volume V that is at the initial pressure 0, the pressure within the container after time t can be considered to be P=P0 {1−exp(−nC/V)t}. The time required for a 63% response is equal to the time constant V/nC, where n is set so that the sum of this value and the response speed of the circuit will be less than the response speed of the sensor required in (1).

Note that, although explained in the sections on “preventing deposition of contaminating substances” in the Example and the Another Example, described above, the deposition of the contaminating substances onto the sensor diaphragm 31a is prevented because, even after passing through the baffle structure 70 or 80, the fluid that is subject to measurement will pass through the inlet hole 21a of the first pedestal plate 21, the slit-shaped space (the cavity) 20A, and the outlet hole 22a of the second pedestal plate 22.

That is, the fluid that is subject to measurement (the gas) from the inlet portion 10A passes through the baffle structure 70 or 80, and then flows from the inlet hole 21a of the first pedestal plate 21 into the slit-shaped space (the cavity) 20A between the first pedestal plate 21 and the second pedestal plate 22.

The gas that is subject to measurement that has flowed into the slit-shaped space (the cavity) 20A necessarily advances in the crosswise direction through the slit-shaped opening (the cavity) 20A because the inlet hole 21a of the first pedestal plate 21 and the outlet hole 22a of the second pedestal plate 22 are positioned so as to not overlap in the direction of thickness of the first pedestal plate 21 and the second pedestal plate 22.

When advancing in the crosswise direction through the slit-shaped space (the cavity) 20A, the contaminating substances that are mixed, in a gaseous state, into the fluid that is subject to measurement has the opportunity to be deposited on the inner surfaces of the first pedestal plate 21 and the second pedestal plate 22. As a result, the amount of contaminating substances that arrives ultimately at the sensor diaphragm 31a in a gaseous state, after having passed through the outlet hole 22a of the second pedestal plate 22, will be small, and thus the amount of contaminating substances that are deposited onto the sensor diaphragm 31a will be reduced.

Moreover, because the inlet hole 21a is provided in the center portion of the first pedestal plate 21 and the outlet holes 22a are provided in a plurality at the peripheral edge portion, at equal distances in the radial direction from the center of the second pedestal plate 22, with equal spacing in the circumferential direction thereof, in the second pedestal plate 22, the contaminating substances that ultimately arrive at the sensor diaphragm 31a after passing through the outlet holes 22a of the second pedestal plate 22 will be deposited with a good balance on the peripheral portion of the sensor diaphragm 31a, away from the center portion thereof, which is the most sensitive portion. As a result, it is possible to greatly mitigate the effect of the zero point shift through the deposition of contaminating substances onto the sensor diaphragm 31a, by avoiding the deposition of contaminating substances onto the center portion of the surface of the sensor diaphragm 31a.

### Extended Examples

While the present disclosure has been explained above in reference to examples, the present disclosure is not limited to the examples set forth above. The structures and details in the present disclosure may be varied in a variety of ways, as can be understood by one skilled in the art, within the scope of technology in the present disclosure.

1. An electrostatic capacitive pressure sensor comprising:
a housing having an inlet portion for a fluid that is subject to measurement;
a sensor chip that detects, as a change in electrostatic capacitance, a change in a diaphragm that flexes upon receipt of a pressure of the fluid that is subject to measurement, which has entered through the inlet portion; and
a baffle that prevents deposition, onto the diaphragm, of a contaminating substance included in the fluid that is subject to measurement, provided within a flow path of the fluid that is subject to measurement between the inlet portion and the diaphragm, wherein:
the baffle structure is a cylindrical structure that is closed on one end, disposed with the direction that is perpendicular to a pressure-bearing surface of the diaphragm as the axial direction; and
a plurality of flow paths wherein the fluid that is subject to measurement passes between the inner peripheral surface and the outer peripheral surface of the cylindrical structure is provided in multiple layers in the axial direction.

2. An electrostatic capacitive pressure sensor as set forth in claim 1, wherein:
the baffle structure is provided so that:
the fluid that is subject to measurement is introduced into the inner peripheral surface side;
the fluid that is subject to measurement, which has been introduced into the inner peripheral surface side, passes through the flow paths in the individual layers that are provided in the axial direction, to flow out on the outer peripheral surface side; and
the fluid that is subject to measurement, which flows out at the outer peripheral surface side, merges and is supplied to the diaphragm.

3. An electrostatic capacitive pressure sensor as set forth in claim 1, wherein:
the baffle structure is provided so that:
the fluid that is subject to measurement is introduced into the outer peripheral surface side;
the fluid that is subject to measurement, which has been introduced into the outer peripheral surface side, passes through the flow paths in the individual layers that are provided in the axial direction, to flow out from the inner peripheral surface side; and
the fluid that is subject to measurement, which flows out from the inner peripheral surface side, merges and is supplied to the diaphragm.

4. An electrostatic capacitive pressure sensor as set forth in claim 1, wherein:
the plurality of flow paths, which are provided in multiple layers in the axial direction, extend radially from the center of the cylindrical structure, in parallel with the pressure-bearing surface of the diaphragm.

5. An electrostatic capacitive pressure sensor as set forth in claim 4, wherein:
the width of the flow path gradually narrows toward the inner periphery from the outer periphery.

6. An electrostatic capacitive pressure sensor as set forth in claim 4, wherein:
the shape of the flow path is a straight line within a plane that is parallel to the pressure-bearing surface of the diaphragm.

7. An electrostatic capacitive pressure sensor as set forth in claim 4, wherein:
the shape of the flow path is non-linear within a plane that is parallel to the pressure-bearing surface of the diaphragm.

8. An electrostatic capacitive pressure sensor as set forth in claim 1, wherein:
the plurality of flow paths, which are provided in multiple layers in the axial direction, are formed by a slit that is provided in parallel with the pressure-bearing surface of the diaphragm, and spaces between obstacles that are provided within the slit.

9. An electrostatic capacitive pressure sensor as set forth in claim 1, wherein:
the baffle structure comprises:
a top plate having, in a center portion of the plate surface, a first inlet hole for guiding the fluid that is subject to measurement that is supplied from an inlet portion of the housing;
a flow path forming plate that has, in a center portion of the plate surface, a second inlet hole for guiding the fluid that is subject to measurement, which is supplied through the first inlet hole of the top plate, and which has a flow path channel that is formed as a plurality of flow paths on the plate surface; and
a base plate that has a plate surface that closes the end surface of the diaphragm side of the flow path forming plate, wherein:
at least one said flow path forming plate is stacked between the top plate and the base plate; and
the individual plate surfaces of the top plate, the flow path forming plate, and the base plate are brought together and bonded.

10. An electrostatic capacitive pressure sensor as set forth in claim 1, wherein:
the baffle structure comprises:
a top plate having a plate surface that is closed so that the fluid that is subject to measurement, which is supplied from the inlet portion of the housing, does not pass through the plate surface;
a flow path forming plate having a flow path channel that is formed, on the plate surface thereof, as a plurality of flow paths, and has, in the center portion of the plate surface, a second inlet hole for guiding, to the diaphragm side, the fluid that is subject to measurement, which has been guided by the closed plate surface of the top plate, has entered into the flow path channel from the outer peripheral surface side, and has been supplied through the flow path channel; and
a base plate having a third inlet hole for guiding, to the diaphragm side, the fluid that is subject to measurement that has been supplied through the second inlet hole of the flow path forming plate; wherein:
at least one said flow path forming plate is stacked between the top plate and the base plate; and
the individual plate surfaces of the top plate, the flow path forming plate, and the base plate are brought together and bonded.

11. An electrostatic capacitive pressure sensor as set forth in claim 9, wherein:
in the top plate, the opening portion of the first inlet hole is divided into a plurality of holes.
